(19) United States
(12) Patent Application Publication
(10) Pub. No.: US 2025/0103624 A1
(43) Pub. Date: Mar. 27, 2025

(54) COMBINATORIAL PROMPTING FOR LARGE LANGUAGE MODELS

(71) Applicant: INTERNATIONAL BUSINESS MACHINES CORPORATION, Armonk, NY (US)

(72) Inventors: Thomas Andre Maxime Carta, Bordeaux (FR); Daiki Kimura, Midori-ku (JP); Don Joven Ravoy Agravante, Yamato (JP); Michiaki Tatsubori, Oiso (JP)

(21) Appl. No.: 18/473,808

(22) Filed: Sep. 25, 2023

(51) Int. Cl. G06F 16/332; G06F 40/20

(52) U.S. Cl. CPC G06F 16/3329; G06F 40/20

(57) ABSTRACT

An embodiment for generating and employing incrementally optimized combinatorial prompts for tuning a target model. The embodiment may select a predetermined number of examples from a training dataset. The embodiment may concatenate each of the selected examples with a current prompt of a target model to obtain a set of candidate prompts. The embodiment may, for each individual candidate prompt in the set of candidate prompts, calculate a loss value over a validation dataset. The embodiment may replace the current prompt with the individual candidate prompt having a lowest calculated loss value that is less than or equal to an original loss value over the validation set for the current prompt to obtain an updated prompt.

### BACKGROUND

The present application relates generally to computer processing, and more particularly, to generating and employing incrementally optimized combinatorial prompts for tuning a target model.

Large language models (LLMs) are deep neural networks pre-trained on a diverse and large corpus of text. LLMs are now commonly leveraged for performance of several natural language processing tasks. To successfully redeploy pre-trained LLMs for specialized downstream tasks, fine-tuning was typically required to train the model on specific datasets for the specialized downstream task. Recently, as LLMs have significantly increased in scale (making fine-tuning less appealing due to cost), manual prompt design for tuning models has grown in popularity, where instead of fine-tuning weights for each task, only the LLM prompts are changed to fit each task. Accordingly, many businesses employing LLMs continuously strive to employ the most effective prompt-based tuning techniques to increase model accuracy while maintaining overall model performance.

### SUMMARY

According to one embodiment, a method, computer system, and computer program product for generating and employing incrementally optimized combinatorial prompts for tuning a target model is provided. The embodiment may include selecting a predetermined number of examples from a training dataset. The embodiment may also include concatenating each of the selected examples with a current prompt of a target model to obtain a set of candidate prompts. The embodiment may further include, for each individual candidate prompt in the set of candidate prompts, calculating a loss value over a validation dataset. The embodiment may also include replacing the current prompt with the individual candidate prompt having a lowest calculated loss value that is less than or equal to an original loss value over the validation set for the current prompt to obtain an updated prompt.

### BRIEF DESCRIPTION OF THE SEVERAL VIEWS OF THE DRAWINGS

These and other objects, features and advantages of the present disclosure will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an operational flowchart for an exemplary process of generating and employing incrementally optimized combinatorial prompts for tuning a target model according to at least one embodiment;

FIG. 3 depicts a diagrammatic view of the exemplary process of FIG. 2;

FIG. 4 depicts an illustrative algorithm that may be employed to perform an exemplary process of generating and employing incrementally optimized combinatorial prompts for tuning a target model according to at least one embodiment; and

FIG. 5 illustrates a series of tables depicting comparative results (F-1 scores) for entity matching and glossary matching tasks for an exemplary question answering model tuned in accordance with described embodiments and results from comparative models on the same tasks that were tuned using either random sampling or manual selection.

### DETAILED DESCRIPTION

Detailed embodiments of the claimed structures and methods are disclosed herein; however, it can be understood that the disclosed embodiments are merely illustrative of the claimed structures and methods that may be embodied in various forms. The present disclosure may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

According to one aspect, the present disclosure relates to a computer-based method of generating and employing incrementally optimized combinatorial prompts for tuning a target model, the method including: selecting a predetermined number of examples from a training dataset, concatenating each of the selected examples with a current prompt of a target model to obtain a set of candidate prompts, for each individual candidate prompt in the set of candidate prompts, calculating a loss value over a validation dataset, and replacing the current prompt with the individual candidate prompt having a lowest calculated loss value that is less than or equal to an original loss value over the validation set for the current prompt to obtain an updated prompt. Thus, described methods iteratively add prompt components by leveraging examples from a training dataset which result in minimal loss, incrementally increasing the specificity and relevance of the prompt to elicit more accurate responses from the target model.

In embodiments, repeatedly generating and employing the incrementally optimized combinatorial prompts for tuning the target model may further include: processing subsequent batches of examples from the training dataset, in an amount corresponding to the predetermined number of examples, until employing the incrementally optimized combinatorial prompt would yield a minimum loss value that is greater than or equal to a comparative loss value over the validation set associated with a most recent updated prompt. Thus, described embodiments provide for improved tuning of the target model by employing incrementally optimized combinatorial prompts by processing subsequent batches of examples from the training dataset until there is no discernible benefit to updating a most recent updated prompt with respect to a calculated minimum loss value or a given validation set.

In embodiments, the target model may be a question-answering system. In such embodiments, the question-answering system allows for the performance of a variety of tasks, such as, for example, entity matching and glossary matching, with improved accuracy as a result of the questioning-answering system being tuned using described combinatorial prompts.

In another embodiment, repeatedly generating and employing the incrementally optimized combinatorial prompts for tuning the target model may include processing subsequent batches of examples from the training dataset, in an amount corresponding to the predetermined number of examples, until a predetermined threshold of examples has been incorporated into the prompt. This allows a user to configure when the tuning of the target model is completed according to how many examples have been incorporated into the prompt rather than by continuing indefinitely until there is no discernible benefit with respect to loss over a validation set.

In another embodiment, selecting the predetermined number of examples from the training dataset further includes performing centroid-based selection, based on geometrical techniques, of the predetermined number of examples. This provides for improved selection of the predetermined number of examples from a training dataset when compared to conventional methods of manual or random selection.

In yet another embodiment, selecting the predetermined number of examples from the training dataset further includes performing a random search of the training dataset for hyperparameters comprising the predetermined number of examples. This provides for yet another improved method of selecting the predetermined number of examples from a training dataset when compared to conventional methods of manual or random selection.

In embodiments, described methods may further include continuously calculating a minimum loss value for a most-updated prompt to provide a baseline loss value. Thus, described embodiments may incrementally optimized generated and employed combinatorial prompts based on a calculated minimum loss value that will allow systems employing described embodiments to determine when no discernible benefit is gained by incorporating a given candidate combinatorial prompt for tuning of a given target model.

In another aspect, the present disclosure relates to a computer system, the computer system including one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, the computer system capable of performing a method including selecting a predetermined number of examples from a training dataset, concatenating each of the selected examples with a current prompt of a target model to obtain a set of candidate prompts, for each individual candidate prompt in the set of candidate prompts, calculating a loss value over a validation dataset, and replacing the current prompt with the individual candidate prompt having a lowest calculated loss value that is less than or equal to an original loss value over the validation set for the current prompt to obtain an updated prompt. Thus, described computer systems may iteratively add prompt components by leveraging examples from a training dataset which result in minimal loss, incrementally increasing the specificity and relevance of the prompt to elicit more accurate responses from the target model.

In yet another aspect, the present disclosure relates to a computer program product, the computer program product including one or more computer-readable tangible storage medium and program instructions stored on at least one of the one or more computer-readable tangible storage medium, the program instructions executable by a processor capable of performing a method, the method including selecting a predetermined number of examples from a training dataset, concatenating each of the selected examples with a current prompt of a target model to obtain a set of candidate prompts, for each individual candidate prompt in the set of candidate prompts, calculating a loss value over a validation dataset, and replacing the current prompt with the individual candidate prompt having a lowest calculated loss value that is less than or equal to an original loss value over the validation set for the current prompt to obtain an updated prompt. Thus, described computer program products may iteratively add prompt components by leveraging examples from a training dataset which result in minimal loss, incrementally increasing the specificity and relevance of the prompt to elicit more accurate responses from the target mode.

Embodiments of the present application relate generally to computer processing, and more particularly, to generating and employing incrementally optimized combinatorial prompts for tuning a target model. The following described exemplary embodiments provide a system, method, and program product to, among other things, select a predetermined number of examples from a training dataset, concatenate each of the selected examples with a current prompt of a target model to obtain a set of candidate prompts, for each individual candidate prompt in the set of candidate prompts, calculate a loss value over a validation dataset, and replace the current prompt with the individual candidate prompt having a lowest calculated loss value that is less than or equal to an original loss value over the validation set for the current prompt to obtain an updated prompt.

As previously described, large language models (LLMs) are deep neural networks pre-trained on a diverse and large corpus of text. LLMs are now commonly leveraged for performance of several natural language processing tasks. To successfully redeploy pre-trained LLMs for specialized downstream tasks, fine-tuning was typically required to train the model on specific datasets for the specialized downstream task. Recently, as LLMs have significantly increased in scale (making fine-tuning less appealing due to cost), manual prompt design for tuning models has grown in popularity, where instead of fine-tuning weights for each task, only the LLM prompts are changed to fit each task. Accordingly, many businesses employing LLMs continuously strive to employ the most effective prompt-based tuning techniques to increase model accuracy while maintaining overall model performance.

However, there are many challenges when engineering prompts for tuning large language models. For example, when engineering hard prompts, given their future potential for increasing capabilities of LLMs while keeping explainability at the token level as opposed to soft prompts, it is difficult to identify the best possible hard prompts when the only restriction is the LLMs vocabulary (tokens). This is because the space of possibilities (number of possible permutations) can be impractically large. Accordingly, alternative prompt engineering methods rely upon crude solutions such as random sampling procedures or leveraging human intuition for carrying out manual selection. These approaches may limit a given model's performance and result in the inclusion of inefficient examples within prompts. Thus, the challenge of only including the most efficient examples to generate shorter prompts, if overcome, would allow for exploration of textual space more efficiently and systematically, thereby increasing accuracy and speed during performance of a variety of tasks.

Accordingly, a method, computer system, and computer program product for generating and employing incrementally optimized combinatorial prompts for tuning a target model would be advantageous. The method, system, and computer program product may select a predetermined number of examples from a training dataset. The method, system, computer program product may concatenate each of the selected examples with a current prompt of a target model to obtain a set of candidate prompts. The method, system, computer program product may then, for each individual candidate prompt in the set of candidate prompts, calculating a loss value over a validation dataset. Thereafter, the method, system, computer program product may replace the current prompt with the individual candidate prompt having a lowest calculated loss value that is less than or equal to an original loss value over the validation set for the current prompt to obtain an updated prompt. In turn, the method, system, computer program product has provided for improved generating and employing of incrementally optimized combinatorial prompts for tuning a target model. Described embodiments provide for an incremental prompt engineering method that gradually refines prompts while ensuring reliable performance. Described embodiments iteratively add prompt components by leveraging examples from a training dataset which result in minimal loss, incrementally increasing the specificity and relevance of the prompt to elicit more accurate responses from the target model. Described embodiments may repeatedly generate and employ incrementally optimized combinatorial prompts for tuning the target model by processing subsequent batches of examples from the training dataset until there is no discernible benefit to updating a most recent updated prompt with respect to a calculated minimum loss value or a given validation set.

The present invention may be a system, a method, and/or a computer program product at any possible technical detail level of integration. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

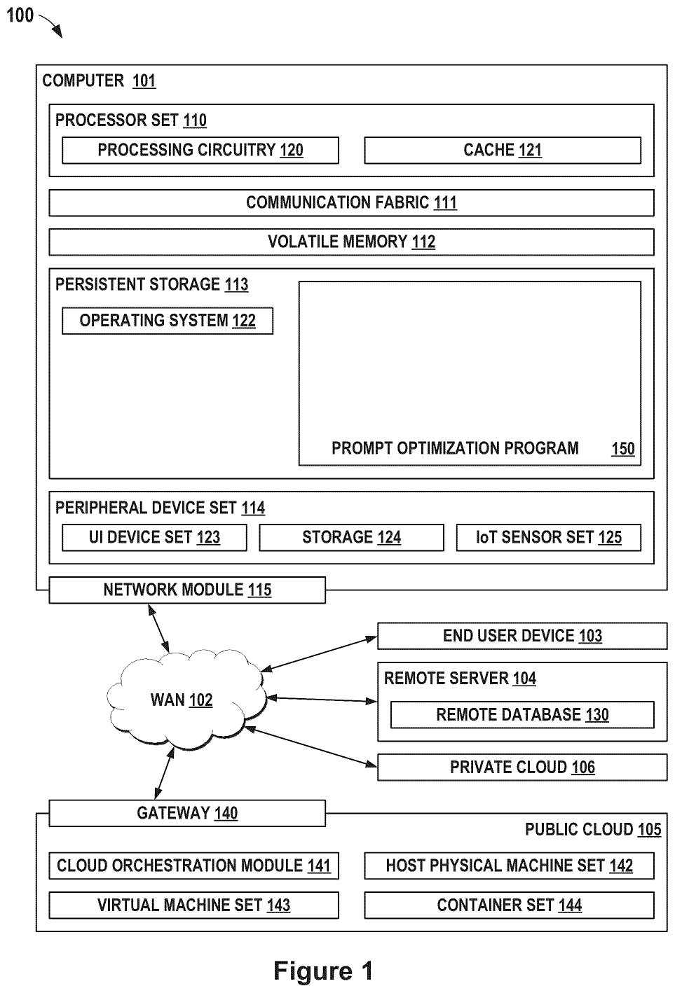

Referring now to FIG. 1, computing environment 100 contains an example of an environment for the execution of at least some of the computer code involved in performing the inventive methods, such as prompt optimization program/code 150. In addition to prompt optimization code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and prompt optimization code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in prompt optimization code 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in prompt optimization program 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the prompt optimization program 150 may be a program capable of selecting a predetermined number of examples from a training dataset. Prompt optimization program 150 may then identify a defect in the printing operation based on the tracked print data. Next, prompt optimization program 150 may concatenate each of the selected examples with a current prompt of a target model to obtain a set of candidate prompts. Prompt optimization program 150 may then, for each individual candidate prompt in the set of candidate prompts, calculate a loss value over a validation dataset. Thereafter, prompt optimization program 150 replace the current prompt with the individual candidate prompt having a lowest calculated loss value that is less than or equal to an original loss value over the validation set for the current prompt to obtain an updated prompt. In turn, prompt optimization program 150 has provided for improved generating and employing of incrementally optimized combinatorial prompts for tuning a target model. Described embodiments provide for an incremental prompt engineering method that gradually refines prompts while ensuring reliable performance. Described embodiments iteratively add prompt components by leveraging examples from a training dataset which result in minimal loss, incrementally increasing the specificity and relevance of the prompt to elicit more accurate responses from the target model. Described embodiments may repeatedly generate and employ incrementally optimized combinatorial prompts for tuning the target model by processing subsequent batches of examples from the training dataset until there is no discernible benefit to updating a most recent updated prompt with respect to a calculated minimum loss value or a given validation set.

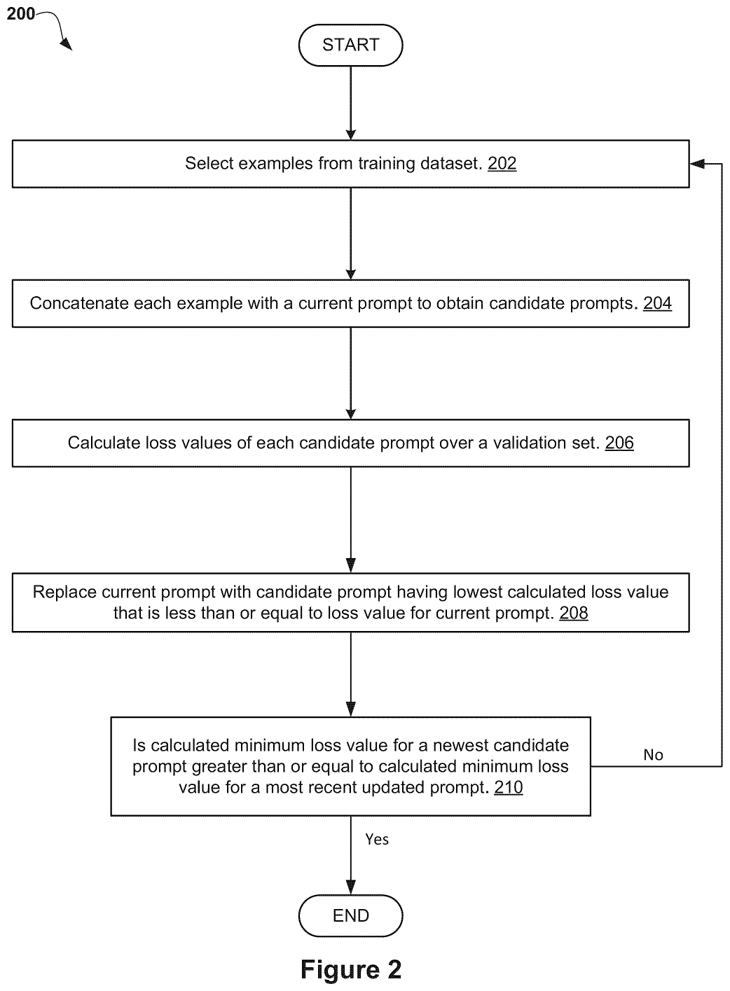

Referring now to FIG. 2, an operational flowchart for an illustrative process 200 of generating and employing incrementally optimized combinatorial prompts for tuning a target model according to at least one embodiment is provided.

At 202, prompt optimization program 150 may select a predetermined number of examples from a training dataset. For example, at this step, prompt optimization program 150 may be configured to select a predetermined batch of 10 examples from an exemplary training dataset ‘D’. In some embodiments in which a dataset is large, prompt optimization program 150 may be configured to search for k best prompt examples in the corresponding high search space. For example, in some embodiments including large training datasets, prompt optimization program 150 may be configured to perform centroid-based selection, leveraging geometrical techniques to find k best prompt examples in an exponentially high search space by finding c centroids and then finding n closest neighbors and only sampling among them to find the predetermined number of examples from the training dataset. These methods for selecting the predetermined number of examples from the training dataset may be significantly more efficient when compared to methods such as grid searches within training datasets that are large and have high dimensional space. In other embodiments, optimization program 150 may be configured to perform random searches such that different examples from the training dataset that may be combined into a given prompt may be seen as ‘hyper-parameters’ (Random Search for Hyper-Parameters).

At 204, prompt optimization program 150 may then concatenate each of the selected examples with a current prompt of a target model to obtain a set of candidate prompts. For example, for a current exemplary prompt “P′ of an exemplary target model ‘T’, prompt optimization program 150 may concatenate each of the selected 10 exemplary examples ‘E1’-‘E10’ with current prompt “P′ to obtain a set of candidate prompts including 10 separate combinatorial prompts. The obtained candidate prompts may then be compared with the original current prompt to evaluate if the candidate prompts would be a suitable replacement for the original current prompt.

Next, at 206, prompt optimization program 150 may, for each individual candidate prompt in the set of candidate prompts, calculate a loss value over a validation dataset. Returning to the example above, at this step, prompt optimization program 150 may calculate a loss value over any suitable validation set for each of the candidate prompts obtained at step 204. For example, prompt optimization program 150 may calculate a loss value over an exemplary validation dataset “V′ for a first candidate prompt ‘CP1’, which was obtained by concatenating an illustrative example ‘E1’ with the current prompt ‘P’. The calculated loss value for each of the candidate prompts may then be compared with the loss value associated with the original prompt ‘P’ to identify which candidate prompt would be a most efficient and suitable replacement for the original current prompt ‘P’.

At 208, prompt optimization program 150 may replace the current prompt with the individual candidate prompt having a lowest calculated loss value that is less than or equal to an original loss value over the validation set for the current prompt to obtain an updated prompt. Returning to the example above, if a series of candidate prompts ‘CP1’-′CP10′ are obtained, prompt optimization program 150 would calculate loss values over an exemplary validation dataset ‘V’ for each of the series of candidate prompts at 206. At step 208, prompt optimization program 150 will replace the original current prompt ‘P’ with the candidate prompt, for example ‘CP1’, having the lowest calculated loss value that is less than or equal to an original loss value over the validation set for the current prompt ‘P’ to obtain an updated prompt ‘UP1’. It should be noted that prompt optimization program 150 will only replace the original current prompt with the candidate prompt having the lowest calculated loss value over the validation set when the loss value for the candidate prompt is less than or equal to the original loss value over the validation set for the original current prompt ‘P’. In other words, the candidate prompt will only be used as a replacement if that replacement would result in a benefit with respect to the calculated loss over the validation set, thereby ensuring an improvement to the employed prompt for the target model.

In embodiments, as shown at 210, prompt optimization program 150 may be configured to repeatedly generating and employing the incrementally optimized combinatorial prompts for tuning the target model by processing subsequent batches of examples from the training dataset, in an amount corresponding to the predetermined number of examples, until a calculated minimum loss value for a newest candidate prompt is greater than or equal to a most recent updated prompt. In other words, prompt optimization program 150 will continue to perform steps 202-208 described above to incrementally optimize the combinatorial prompt employed by the target model. In embodiments, prompt optimization program 150 may be configured to repeat steps 202-208 until a calculated minimum loss value for a newest candidate prompt is greater than or equal to a calculated loss value for a most recent updated prompt. In other words, prompt optimization program 150 may continue until further updates to a most recent version of the prompt (newest prompt) would yield no discernable benefit with respect to a calculated minimum loss value (comparative loss value) over the validation set for a most recent updated prompt. Accordingly, prompt optimization program 150 continuously and iteratively calculates a loss value over the validation set for a most-recently updated prompt each time a given prompt is updated and replaced by a given candidate prompt. The calculated loss value corresponding to the most-recently updated prompt then functions as a baseline for determining whether future updates or replacements would be beneficial with regards to calculated loss value.

In other embodiments, prompt optimization program 150 may be configured to repeat steps 202-208 until a predetermined number of examples, in other words a threshold of examples, have been incorporated into the current prompt ‘P’. For example, prompt optimization program 150 may be configured to repeat steps 202-208 until a threshold of 3 examples have been incorporated into the original current prompt ‘P’.

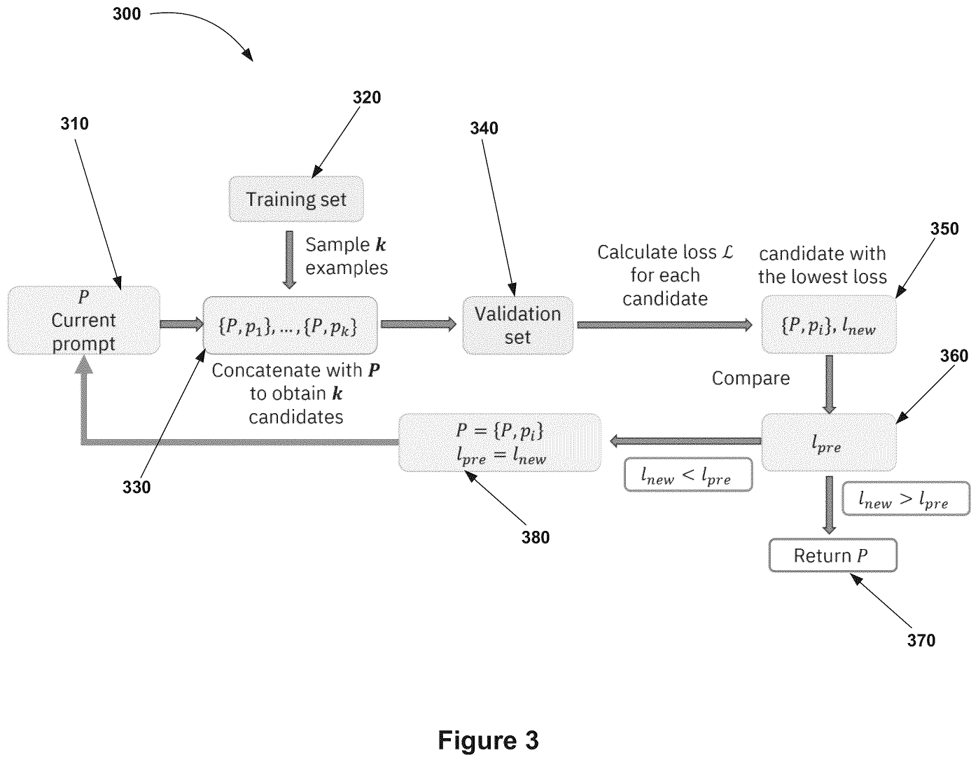

FIG. 3 depicts a diagrammatic view of the exemplary process 300 for generating and employing incrementally optimized combinatorial prompts for tuning a target model in accordance with described embodiments and with the above-described steps of process 200 in FIG. 2.

In FIG. 3, a current prompt ‘P’ at 310 is being optimized for tuning of a target model (not shown). A training dataset at 320 provides a source for prompt optimization program 150 to select batches or samples including ‘k’ examples to be concatenated with current prompt ‘P’ at 330 to obtain ‘k’ candidate prompts. Prompt optimization program 150 may then leverage a validation set at 340 to calculate a loss value for each candidate prompt. At 350, a candidate with the lowest calculated loss over the validation set at 330 represented by ‘l_{new}’ may then be compared with the loss value associated with the original current prompt at 360 represented by ‘lₚᵣₑ’. If the calculated loss value corresponding to ‘l_{new}’ is greater than the loss value corresponding to ‘lₚᵣₑ’ then the original prompt ‘P’ will be returned at 370 without being replaced or altered. If instead the calculated loss value corresponding to ‘l_{new}’ is lower than the loss value corresponding to ‘lₚᵣₑ’ then the original prompt ‘P’ will be replaced at 380 by the candidate prompt that had the lowest calculated loss.

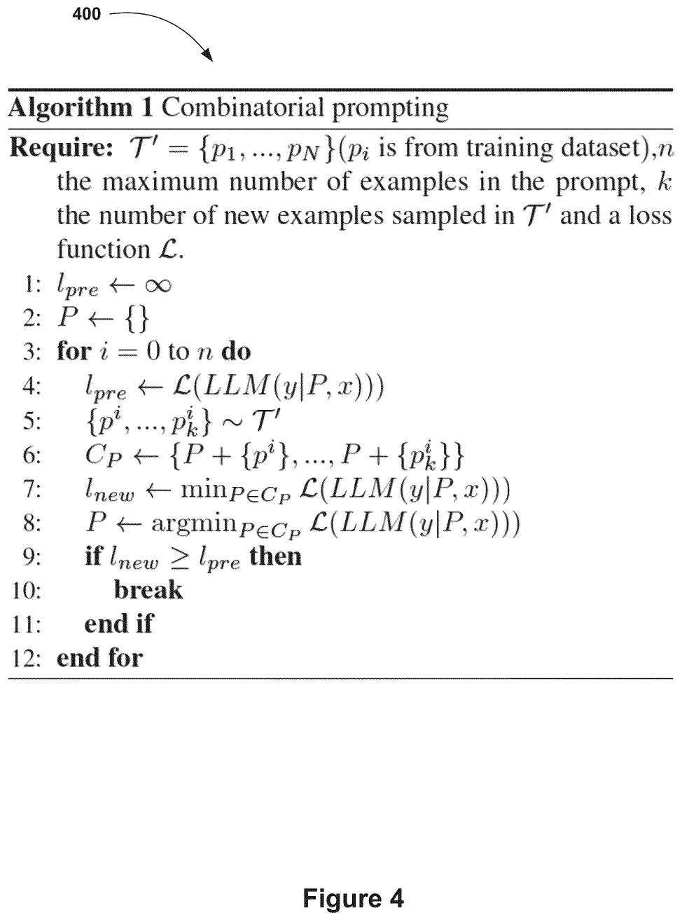

FIG. 4 depicts an illustrative algorithm depicts an illustrative algorithm that may be employed to perform an exemplary process of generating and employing incrementally optimized combinatorial prompts for tuning a target model according to at least one embodiment. Algorithm 400 shown in FIG. 4 may be used to carry out the process depicted in FIG. 3 described above for generating incrementally optimized combinatorial prompts.

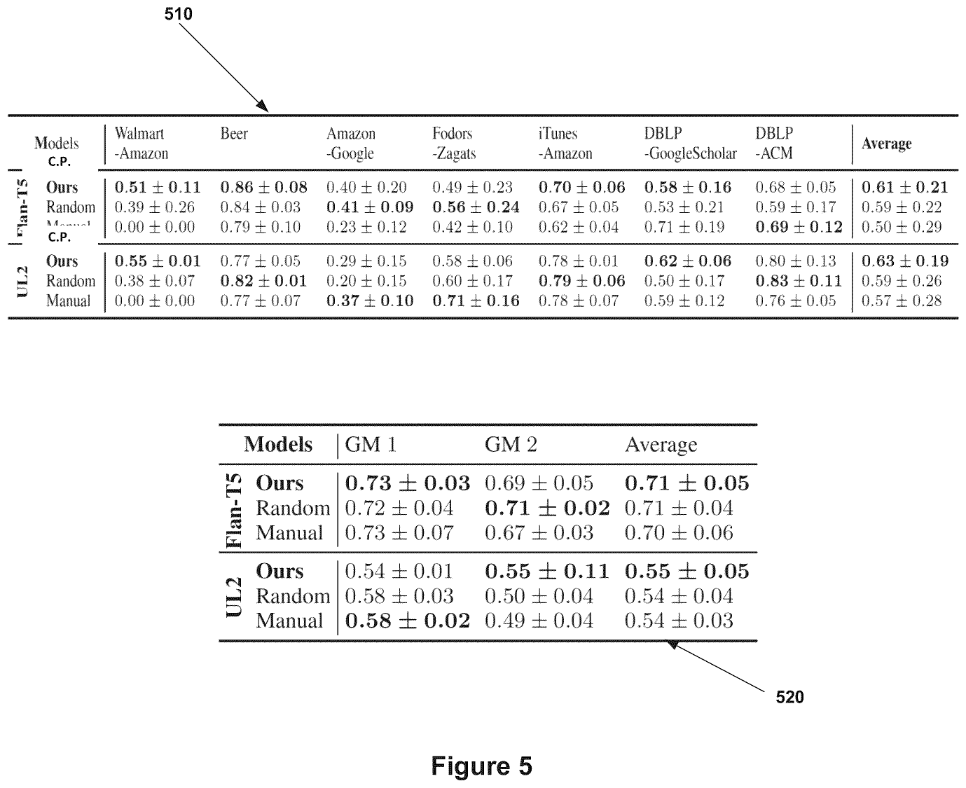

FIG. 5 illustrates a series of tables depicting comparative results (F-1 scores) for entity matching and glossary matching tasks for an exemplary question answering model tuned in accordance with described embodiments and comparative models tuned using either random sampling or manual selection. The models performed these tasks for 9 diverse and publicly available datasets, each of which is represented by the column titles shown in Table 510, ‘DBLP.ACM, DBLP.GoogleScholar, etc. For example, the table shown at 510 depicts the entity matching task results for two separate language models ‘Flan-T5’ and ‘UL2’ respectively, that have been tuned using described embodiments for generating incrementally optimized combinatorial prompts represented by the row labeled ‘C.P’. Table 510 also includes comparative entity matching task results for the same two language models tuned using random sampling and manual selection represented by the rows labeled ‘random’ and ‘manual’ respectively. The results in Table 510 contain an average value over 5 seeds with the standard deviation. It may be noted that the presently described embodiments provide for the highest average F-1 score for both of the models with more favorable standard deviations.

FIG. 5 further depicts a second table 520 including glossary matching task results of testing the same two separate language models, ‘Flan-T5’ and ‘UL2’ respectively, that have been tuned using described embodiments represented by the row labeled ‘Combinatorial’. Table 520 also includes comparative glossary matching task results for the same two language models tuned using random sampling and manual selection represented by the rows labeled ‘random’ and ‘manual’ respectively. The results in Table 520 also contain an average value over 5 seeds with the standard deviation. It may be noted that the presently described embodiments provide for similar F-1 scores for both models for the glossary matching task.

It may be appreciated that prompt optimization program 150 has thus provided improved generating and employing of incrementally optimized combinatorial prompts for tuning a target model. Described embodiments provide for an incremental prompt engineering method that gradually refines prompts while ensuring reliable performance. Described embodiments iteratively add prompt components by leveraging examples from a training dataset which result in minimal loss, incrementally increasing the specificity and relevance of the prompt to elicit more accurate responses from the target model. Described embodiments may repeatedly generate and employ incrementally optimized combinatorial prompts for tuning the target model by processing subsequent batches of examples from the training dataset until there is no discernible benefit to updating a most recent updated prompt with respect to a calculated minimum loss value or a given validation set. Furthermore, described embodiments have been shown to allow for better or similar performance when compared to randomly or manually tuned language models, while providing for shorter prompts. This is beneficial because shorter prompts are preferred as it allows less computation from the LLM. Shorter prompts generated by described embodiments thus allow for exploration of textual space more efficiently and systematically than manual searches.

It may be appreciated that FIGS. 2-5 provide only illustrations of an exemplary implementation and do not imply any limitations with regard to how different embodiments may be implemented. Many modifications to the depicted environments may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein

What is claimed is:

1. A computer-based method of generating and employing incrementally optimized combinatorial prompts for tuning a target model, the method comprising:
selecting a predetermined number of examples from a training dataset;
concatenating each of the selected examples with a current prompt of a target model to obtain a set of candidate prompts;
for each individual candidate prompt in the set of candidate prompts, calculating a loss value over a validation dataset; and
replacing the current prompt with the individual candidate prompt having a lowest calculated loss value that is less than or equal to an original loss value over the validation set for the current prompt to obtain an updated prompt.

2. The computer-based method of claim 1, further comprising:
repeatedly generating and employing the incrementally optimized combinatorial prompts for tuning the target model by:
processing subsequent batches of examples from the training dataset, in an amount corresponding to the predetermined number of examples, until employing the incrementally optimized combinatorial prompt would yield a minimum loss value that is greater than or equal to a comparative loss value over the validation set associated with a most recent updated prompt.

3. The computer-based method of claim 1, wherein the target model comprises a question-answering system.

4. The computer-based method of claim 1, further comprising:
repeatedly generating and employing the incrementally optimized combinatorial prompts for tuning the target model by:
processing subsequent batches of examples from the training dataset, in an amount corresponding to the predetermined number of examples, until a predetermined threshold of examples has been incorporated into the prompt.

5. The computer-based method of claim 1, wherein selecting the predetermined number of examples from the training dataset further comprises:
performing centroid-based selection, based on geometrical techniques, of the predetermined number of examples.

6. The computer-based method of claim 1, wherein selecting the predetermined number of examples from the training dataset further comprises:
performing a random search of the training dataset for hyperparameters comprising the predetermined number of examples.

7. The computer-based method of claim 1, further comprising:
continuously calculating a minimum loss value for a most-updated prompt to provide a baseline loss value.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
selecting a predetermined number of examples from a training dataset;
concatenating each of the selected examples with a current prompt of a target model to obtain a set of candidate prompts;
for each individual candidate prompt in the set of candidate prompts, calculating a loss value over a validation dataset; and
replacing the current prompt with the individual candidate prompt having a lowest calculated loss value that is less than or equal to an original loss value over the validation set for the current prompt to obtain an updated prompt.

9. The computer system of claim 8, further comprising:
repeatedly generating and employing the incrementally optimized combinatorial prompts for tuning the target model by:
processing subsequent batches of examples from the training dataset, in an amount corresponding to the predetermined number of examples, until employing the incrementally optimized combinatorial prompt would yield a minimum loss value that is greater than or equal to a comparative loss value over the validation set associated with a most recent updated prompt.

10. The computer system of claim 8, wherein the target model comprises a question-answering system.

11. The computer system of claim 8, further comprising:
repeatedly generating and employing the incrementally optimized combinatorial prompts for tuning the target model by:
processing subsequent batches of examples from the training dataset, in an amount corresponding to the predetermined number of examples, until a predetermined threshold of examples has been incorporated into the prompt.

12. The computer system of claim 8, wherein selecting the predetermined number of examples from the training dataset further comprises:
performing centroid-based selection, based on geometrical techniques, of the predetermined number of examples.

13. The computer system of claim 8, wherein selecting the predetermined number of examples from the training dataset further comprises:
performing a random search of the training dataset for hyperparameters comprising the predetermined number of examples.

14. The computer system of claim 8, further comprising:
continuously calculating a minimum loss value for a most-updated prompt to provide a baseline loss value.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
selecting a predetermined number of examples from a training dataset;
concatenating each of the selected examples with a current prompt of a target model to obtain a set of candidate prompts;
for each individual candidate prompt in the set of candidate prompts, calculating a loss value over a validation dataset; and
replacing the current prompt with the individual candidate prompt having a lowest calculated loss value that is less than or equal to an original loss value over the validation set for the current prompt to obtain an updated prompt.

16. The computer program product of claim 15, further comprising:
repeatedly generating and employing the incrementally optimized combinatorial prompts for tuning the target model by:
processing subsequent batches of examples from the training dataset, in an amount corresponding to the predetermined number of examples, until employing the incrementally optimized combinatorial prompt would yield a minimum loss value that is greater than or equal to a comparative loss value over the validation set associated with a most recent updated prompt.

17. The computer program product of claim 15, wherein the target model comprises a question-answering system.

18. The computer program product of claim 15, further comprising:
repeatedly generating and employing the incrementally optimized combinatorial prompts for tuning the target model by:
processing subsequent batches of examples from the training dataset, in an amount corresponding to the predetermined number of examples, until a predetermined threshold of examples has been incorporated into the prompt.

19. The computer program product of claim 15, wherein selecting the predetermined number of examples from the training dataset further comprises:
performing centroid-based selection, based on geometrical techniques, of the predetermined number of examples.

20. The computer program product of claim 18, wherein selecting the predetermined number of examples from the training dataset further comprises:
performing a random search of the training dataset for hyperparameters comprising the predetermined number of examples.
